(19) United States
(12) Patent Application Publication
(10) Pub. No.: US 2022/0207949 A1
(43) Pub. Date: Jun. 30, 2022

(54) SHEET PROCESSING APPARATUS

(71) Applicant: Glory Ltd., Himeji-shi (JP)

(72) Inventor: Yusaku TACHIBANA, Hyogo (JP)

(73) Assignee: Glory Ltd., Himeji-shi (JP)

(21) Appl. No.: 17/696,882

(22) Filed: Mar. 17, 2022

Related U.S. Application Data
(63) Continuation of application No. PCT/JP2020/033383, filed on Sep. 3, 2020.

(30) Foreign Application Priority Data
Sep. 20, 2019 (JP) 2019-171930

(51) Int. Cl. G07D 11/13; B65H 29/00; B65H 43/00

(52) U.S. Cl. CPC G07D 11/13; B65H 29/006; B65H 43/00; G07D 2211/00; B65H 2513/104; B65H 2301/41912; B65H 2701/1912

(57) ABSTRACT

A sheet processing apparatus includes: a first storage that is a winding-type storage unit where a sheet is wound around a drum together with a tape and stored; a second storage that stores the sheet; a transport unit that transports the sheet to the second storage at a first transport speed and transports the sheet from the second storage to the first storage at a second transport speed; and a processing circuitry that controls the first storage, the second storage, and the transport unit so that the second transport speed is slower than the first transport speed and a winding speed for winding the sheet by the first storage is a first winding speed that is slower than the second transport speed.

### Cross-Reference to Related Applications

This application is a bypass continuation of International Patent Cooperation Treaty Application No. PCT/JP2020/033383, filed on Sep. 3, 2020, which claims priority to Japanese Patent Application No. 2019-171930, filed on Sep. 20, 2019, the entire disclosures of each are incorporated herein by reference.

### BACKGROUND ART

A sheet processing apparatus that has been conventionally used comprises a winding-type storage unit in which sheets are stored by being wound around a drum together with a tape.

### SUMMARY

A sheet processing apparatus according to the present disclosure comprises: a first storage that is a winding-type storage unit where a sheet is wound around a drum together with a tape and stored; a second storage that stores the sheet; a transport unit that transports the sheet to the second storage at a first transport speed and transports the sheet from the second storage to the first storage at a second transport speed; and a processing circuitry that controls the first storage, the second storage, and the transport unit so that the second transport speed is slower than the first transport speed and a winding speed for winding the sheet by the first storage is a first winding speed that is slower than the second transport speed.

### BRIEF DESCRIPTION OF DRAWINGS

FIG. 1 is a schematic diagram of a banknote processing apparatus according to an embodiment;

FIG. 2 is a schematic perspective view of a banknote storage unit;

FIG. 3 is a schematic side view of the banknote storage unit;

FIG. 4A is a conceptual diagram for describing transfer of banknotes between a transport unit and a winding-type storage unit;

FIG. 4B is another conceptual diagram for describing transfer of banknotes between the transport unit and the winding-type storage unit;

FIG. 5 is a diagram illustrating shortened amounts of banknote intervals in a case where banknotes are continuously stored; and

FIG. 6 is a diagram illustrating shortened amounts of banknote intervals in a case where banknotes are intermittently stored.

### DESCRIPTION OF EMBODIMENT

It has been demanded to increase the storage amount in a storage unit.

It is an object of the present disclosure to provide a technique for increasing the storage amount in a storage unit.

According to the present disclosure, it is possible to increase the storage amount in a storage unit.

Hereinafter, an embodiment of the present disclosure will be described in detail with reference to the accompanying drawings. In the following, a banknote processing apparatus that processes banknotes, which correspond to sheets, will be described as a typical example of a sheet processing apparatus according to the present disclosure. Note that the sheets are not limited to banknotes, and may include vouchers, securities, and ballots, for example. The sheets are also not limited to be made of paper, and may include a material other than paper formed into a sheet, or a material other than paper and paper pasted together and formed into a sheet. Resin is an example of the material other than paper.

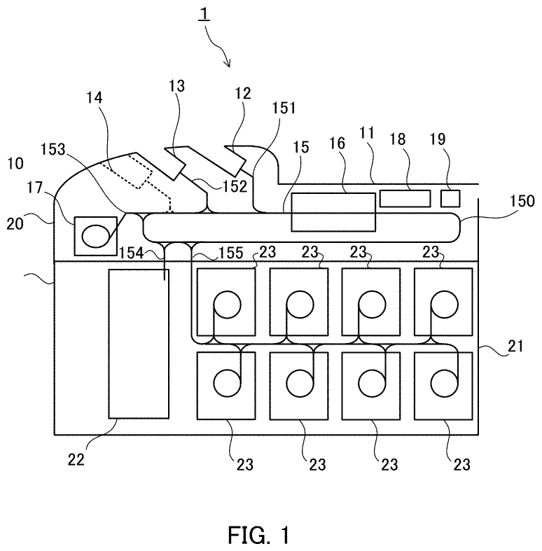

FIG. 1 is a schematic diagram of a banknote processing apparatus 1 according to an embodiment. The banknote processing apparatus 1 illustrated in FIG. 1 is a banknote depositing and dispensing machine for depositing and dispensing banknotes. Note that, in the following description, the “front” of the banknote processing apparatus 1 indicates an operator side where banknotes are fed into an inlet and/or fed out from an outlet, and the “back” of the banknote processing apparatus 1 indicates the other side. In other words, the “front” of the banknote processing apparatus 1 indicates a side where an opening is provided for at least one of the operations of feeding banknotes in and out. Further, the “left” of the banknote processing apparatus 1 indicates the left side as seen from the operator facing the opening, and the “right” of the banknote processing apparatus 1 indicates the right side as seen from the operator facing the opening.

The banknote processing apparatus 1 comprises a processing unit 10 and a storage 20, which is provided under the processing unit 10.

The processing unit 10 comprises an upper housing 11. An inlet 12 where a banknote to be deposited is placed and an outlet 13 where a withdrawn banknote is placed are provided upper front of the upper housing 11. The upper housing 11 may be provided with a second outlet 14, which has the same configuration as that of the outlet 13, next to the outlet 13 as necessary. A transport unit 15, which transports banknotes, a recognition unit 16, which recognizes the banknotes, and a temporary storage unit 17, which temporarily stores the banknotes, are provided inside the upper housing 11. In addition, a processing circuitry 18, which controls each part of the banknote processing apparatus 1, and a memory unit 19 are provided inside the upper housing 11.

The inlet 12 is configured to feed banknotes one by one to the transport unit 15. The outlet 13 is configured to stack banknotes transported by the transport unit 15.

The transport unit 15 is a transport device that transports banknotes at a predetermined transport speed. The transport unit 15 may be configured by either one or a combination of a belt mechanism and a roller mechanism, for example. The transport unit 15 comprises a loop transport path 150, which transports banknotes in a loop, and divergent paths, which are a first divergent path 151, a second divergent path 152, a third divergent path 153, a fourth divergent path 154, and a fifth divergent path 155, diverged from the loop transport path 150.

The first divergent path 151 connects the loop transport path 150 and the inlet 12. The second divergent path 152 connects the loop transport path 150 and the outlet 13. The third divergent path 153 connects the loop transport path 150 and the temporary storage unit 17 to be described later. The fourth divergent path 154 connects the loop transport path 150 and a stacking-type storage unit 22 to be described later. The fifth divergent path 155 connects the loop transport path 150 and a plurality of winding-type storage units 23 to be described later. Note that a diverter (not illustrated) that diverts banknotes is provided at a point where each divergent path is diverged from the loop transport path 150. Further, in a case where the second outlet 14 is provided, another divergent path is provided to connect the loop transport path 150 and the second outlet 14.

The recognition unit 16 is a recognition device that reads information of banknotes and recognizes the banknotes. The recognition unit 16 comprises sensors such as an image sensor, an optical sensor, and a magnetic sensor, and recognizes banknote information of banknotes transported by the transport unit 15, such as authentication, denomination, fitness, and serial numbers.

Note that the serial number is a unique number given to each banknote, and is configured by a 10-digit string of a combination of alphabet letters and numbers, for example. The recognition unit 16 recognizes each of the 10-digit letters and numbers composing the serial number.

The temporary storage unit 17 is a storage device that temporarily stores banknotes. The temporary storage unit 17 can take banknotes one by one to store, and feed out the stored banknotes one by one.

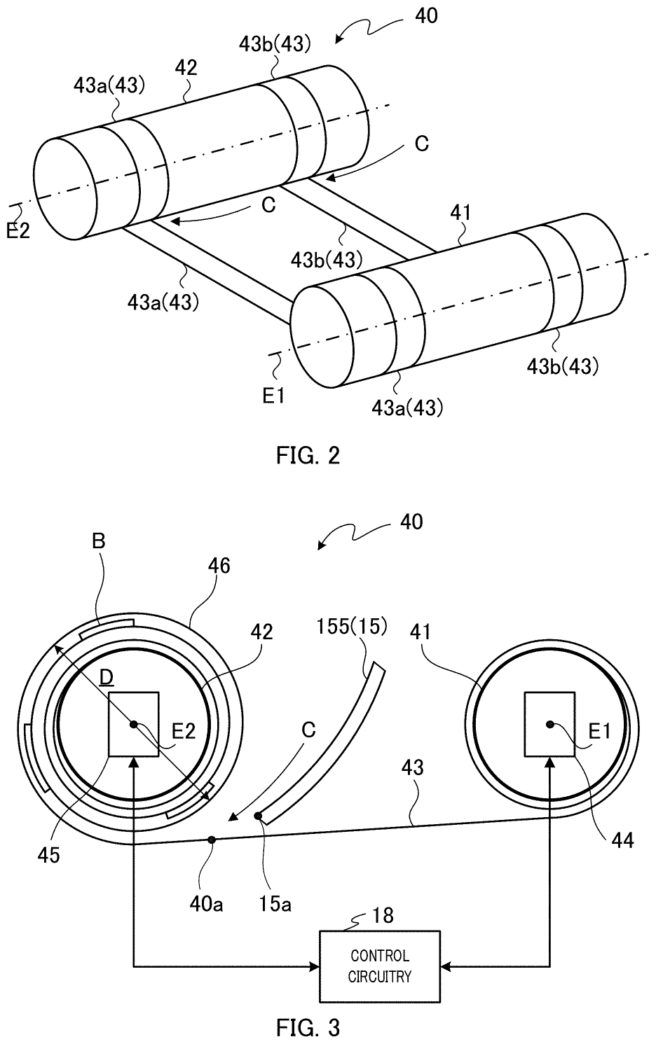

The temporary storage unit 17 is a type of winding-type storage unit in which a plurality of banknotes are wound around a rotating body and stored. The temporary storage unit 17 comprises a banknote storage unit 40 (see FIGS. 2 and 3) to be described later. Note that the temporary storage unit 17 may be configured by a stacking-type storage unit in which a plurality of banknotes are stacked and stored.

The processing circuitry 18 is configured to control operations of the banknote processing apparatus 1. The memory unit 19 is, for example, a nonvolatile memory. The processing circuitry 18 is configured to perform various processing using information stored in the memory unit 19. The processing circuitry 18 controls the transport unit 15 so that banknotes are transported among the inlet 12, the outlet 13, the temporary storage unit 17, the stacking-type storage unit 22, and the winding-type storage units 23.

The storage 20 comprises a lower housing 21. The storage 20 is configured by a lockable chest such as a safe. A lockable chest door (not illustrated) is provided on the front side of the lower housing 21.

Inside the lower housing 21, the stacking-type storage unit 22 and the plurality of (eight in the example illustrated in FIG. 1) winding-type storage units 23 are provided in order from the front.

The stacking-type storage unit 22 is a stacking-type storage unit in which a plurality of banknotes are stacked and stored. The winding-type storage units 23 are winding-type storage units in which a plurality of banknotes are wound around a rotating body and stored. The winding-type storage units 23 respectively comprise the banknote storage units 40 (see FIGS. 2 and 3) to be described later. The winding-type storage units 23 are connected to each other by the fifth divergent path 155.

The entrances to the stacking-type storage unit 22 and the winding-type storage units 23 are each provided with a sensor (not illustrated) that detects passage of a banknote. The sensor is, for example, an optical sensor that comprises a light emitting unit that emits light such as infrared rays, and a light receiving unit that receives light from the light emitting unit. Note that the sensor may be any type of sensor as long as it is capable of detecting passage of a banknote through the entrance.

The banknote storage unit 40 will be described with reference to FIG. 2 and FIG. 3. Note that some of the components illustrated in FIG. 3, such as the processing circuitry 18, are not illustrated in FIG. 2.

In the present embodiment, the banknote storage units 40 are each provided inside the temporary storage unit 17 and the winding-type storage units 23. The banknote storage unit 40 is configured to store banknotes transported by the transport unit 15 and feed out the stored banknotes to the transport unit 15.

As illustrated in FIGS. 2 and 3, the banknote storage unit 40 comprises a reel 41, a drum 42, a pair of tapes 43a and 43b, and drive units 44 and 45. In the following, the pair of tapes 43a and 43b is collectively referred to as a tape 43 as necessary.

Operations of the banknote storage unit 40 are controlled by the processing circuitry 18. To be more specific, the processing circuitry 18 controls the drive units 44 and 45, and stores banknotes in the banknote storage unit 40. Note that the operations of the banknote storage unit 40 may be controlled by a controller other than the processing circuitry 18. The controller may be a single controller or a plurality of controllers. In a case of a plurality of controllers, the banknote storage units 40 may be respectively controlled by different controllers.

The reel 41 rotates around a rotation axis E1 by the operation of the drive unit 44 controlled by the processing circuitry 18. The reel 41 is connected to a first end of the tape 43, and the first end side of the tape 43 is wound around the reel 41.

The drum 42 is provided so that a rotation axis E2 of the drum 42 is parallel to the rotation axis E1 of the reel 41. The drum 42 rotates around the rotation axis E2 by the operation of the drive unit 45 controlled by the processing circuitry 18. The drum 42 is connected to a second end of the tape 43, and the second end side of the tape 43 is wound around the drum 42.

The tape 43 is stretched between the reel 41 and the drum 42 under tension.

The drive unit 44 is, for example, a stepper motor.

The drive unit 45 is, for example, a stepper motor.

The rotation of the reel 41 and the drum 42 when a banknote is being stored in the banknote storage unit 40 is referred to as forward rotation. In a case where the reel 41, the drum 42, and the tape 43 are arranged as illustrated in FIG. 3, the reel 41 and the drum 42 rotate in the same direction (clockwise direction in FIG. 3). At this time, the tape 43 pulled out from the reel 41 is wound around the drum 42 together with a banknote B passed from the transport unit 15. The drum 42 includes a winding body 46 together with the wound tape 43 and the wound banknote B. Note that the reference sign D in FIG. 3 indicates a diameter of the winding body 46. The moving speed of the tape 43 on the outer circumferential surface of the winding body 46 is equal to the moving speed of the tape 43 between the reel 41 and the drum 42. In the following, the moving speed of the tape 43 between the reel 41 and the drum 42 or the moving speed of the tape 43 on the outer circumferential surface of the winding body 46 may be simply referred to as the moving speed of the tape 43.

To be more specific, the banknote B passed from the transport unit 15 is inserted, as indicated by arrows C in FIGS. 2 and 3, between a part of the tape 43 positioned at the outermost circumference of the winding body 46 and another part of the tape 43 stretched between the reel 41 and the drum 42. The inserted banknote B is wound around the drum 42 together with the tape 43 by the rotation of the drum 42. Note that the point indicated by the reference sign 15a in FIG. 3 is a transport-unit-side working point, which is a point closest to the winding-type storage unit 23 (that is, the banknote storage unit 40) in a section where the fifth divergent path 155 (the transport unit 15) exerts a force to the banknote B. In addition, the point indicated by the reference sign 40a in FIG. 3 is a storage-unit-side working point, which is a point closest to the transport unit 15 in a section where the winding-type storage unit 23 exerts a force to the banknote B. That is, the banknote B that has made contact with the storage-unit-side working point 40a is wound into the winding body 46 by the tape 43. Note that a part of the transport unit 15 including the transport-unit-side working point 15a may be placed inside the winding-type storage unit 23. The part of the transport unit 15 may also be configured to be separable from the main body of the transport unit 15 and integrated with the winding-type storage unit 23.

When a banknote is fed out from the banknote storage unit 40, the reel 41 and the drum 42 rotate in a direction opposite to the forward rotation. Such rotation is referred to as reverse rotation in the following. In the case where the reel 41, the drum 42, and the tape 43 are arranged as illustrated in FIG. 3, the reel 41 and the drum 42 rotate in a counter-clockwise direction. At this time, the tape 43 pulled out from the drum 42 is wound around the reel 41. The banknote B is passed to the transport unit 15.

To be more specific, when the tape 43 is pulled out from the drum 42 and wound around the reel 41, the banknote B that has been wound around the drum 42 is released from a state of being caught between a part of the tape 43 and another part of the tape 43. When released, the banknote B is transferred in a direction opposite to the direction indicated by the arrows C, and passed to the transport unit 15.

The processing circuitry 18 can change the moving speed of the tape 43 by controlling the drive units 44 and 45 according to the state of the banknote storage unit 40 or the banknote processing apparatus 1. The moving speed of the tape 43 is the moving speed of the banknote B in the banknote storage unit 40. The moving speed of the tape 43 when the banknote B is being wound up is the winding speed for the banknote B, and the moving speed of the tape 43 when the banknote B is being fed out is the feeding speed for the banknote B.

The processing circuitry 18 can change the tension acting on the tape 43 stretched between the reel 41 and the drum 42 by controlling at least one of the drive units 44 and 45 according to the state of the banknote storage unit 40 or the banknote processing apparatus 1.

The tension acting on the tape 43 can be adjusted by adjusting any one or more of the rotation direction, rotation speed, and torque of the reel 41, and the rotation direction, rotation speed, and torque of the drum 42. The processing circuitry 18 can control the rotation speed and torque of the reel 41 and the drum 42 by controlling the rotation speed and torque of the drive units 44 and 45 using Pulse Width Modulation (PWM), for example.

<Storing Banknotes in Winding-Type Storage Unit>

In the banknote processing apparatus 1 configured as described above, banknotes are stored in the winding-type storage unit 23 in the following manner, for example.

Banknotes that are ready to be passed to the transport unit 15, such as banknotes placed at the inlet 12 or banknotes stored in the temporary storage unit 17, are passed to the transport unit 15. The transport unit 15 continuously transports the received banknotes at a predetermined transport speed. The banknotes are passed to the transport unit 15 at an approximately constant pace, so that the distance (interval) between the leading edge of a banknote moving on the transport unit 15 and the leading edge of the following banknote is approximately equal. When a plurality of banknotes having the equal lengths in the transport direction are continuously transported, the distance (interval) between the tailing edge of a banknote moving on the transport unit 15 and the leading edge of the following banknote is approximately equal. In the following, the distance between the tailing edge of a banknote moving on the transport unit 15 and the leading edge of the following banknote is sometimes referred to as an interval between banknotes. Similarly, the distance between the tailing edge of a banknote transported by the tape 43 and the leading edge of the following banknote is sometimes referred to as an interval between banknotes. Note that the interval between banknotes is determined in advance. When the interval is shorter than the predetermined interval, the recognition unit 16 no longer recognizes each banknote. In this case, the banknote is determined to be, for example, in a multi-feed state or to be a single sheet having a non-standard size, and the banknote that has been transported at a shorter interval is rejected.

The banknotes transported by the transport unit 15 are recognized in the recognition unit 16. The destinations of the banknotes are determined based on the recognition results. The description continues assuming that all the banknotes are transported to a single winding-type storage unit 23.

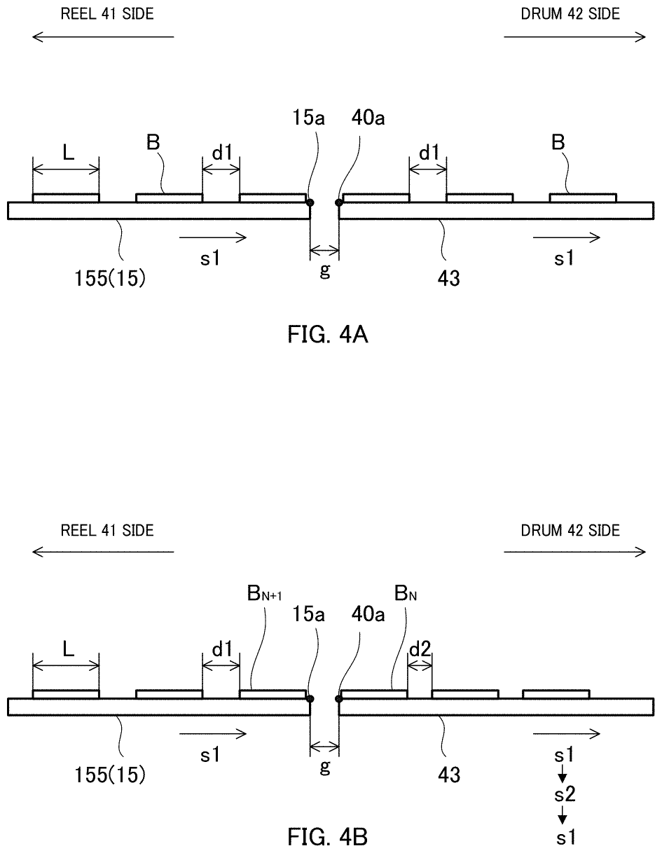

FIGS. 4A and 4B are conceptual diagrams for describing transfer of banknotes between the transport unit 15 and the winding-type storage unit 23 (that is, the banknote storage unit 40). Note that the shapes and layouts do not necessarily match those of the actual apparatus since they are conceptual diagrams.

First, with reference to FIG. 4A, a description will be given of control in a case where the number of banknotes B to be stored in the winding-type storage unit 23 is not intended to be increased.

A banknote B is transported on the fifth divergent path 155 of the transport unit 15 at a speed s1. The banknote B is passed from the fifth divergent path 155 to the banknote storage unit 40, which is specifically the tape 43, provided in the winding-type storage unit 23. The banknote B is transported on the tape 43 at the speed s1, which is equal to the speed of the banknote B transported by the transport unit 15. This speed s1 is the moving speed of the tape 43 and is also the winding speed for the banknote B.

Note that the distance g is the distance between the transport-unit-side working point 15a, which is a point closest to the winding-type storage unit 23 (that is, the banknote storage unit 40) in a section where the fifth divergent path 155 exerts a force to the banknote B, and the storage-unit-side working point 40a, which is a point closest to the transport unit 15 in a section where the winding-type storage unit 23 exerts a force to the banknote B, and the distance g is shorter than the length L of the banknote B in the transport direction. This prevents a situation where the banknote B receives no force from either the transport unit 15 or the winding-type storage unit 23 when the banknote B is transferred between the transport unit 15 and the winding-type storage unit 23, and ensures the transfer of the banknote B. Further, in a case where the banknote processing apparatus 1 is capable of processing a plurality of types of banknotes B having different lengths L in the transport direction from each other, the distance g is configured to be shorter than the transport-direction length of a banknote B having the shortest length L in the transport direction among the plurality of types of banknotes B. This configuration enables reliable transfer for all the banknotes B to be processed.

The interval between the banknotes B being transported by the transport unit 15 is represented by d1. The transport speed for the banknotes B by the transport unit 15 and the moving speed of the banknotes B by the tape 43 are both s1. Thus, the interval between the banknotes B does not change before and after the transfer. That is, the interval between the banknotes B being transported by the tape 43 remains at d1.

Accordingly, the banknotes B are wound around the winding body 46, that is, stored in the winding-type storage unit 23, while keeping the interval d1 between the banknotes B being transported by the transport unit 15.

Next, with reference to FIG. 4B, a description will be given of control capable of increasing the number of banknotes B to be stored in the winding-type storage unit 23.

The difference from the case illustrated in FIG. 4A is that the moving speed of the tape 43 is not constant at s1 but down to s2 from s1 and back to s1. To be more specific, with respect to the transport speed s1 for banknotes transported by the transport unit 15, the moving speed of the tape 43 is decelerated from s1 to s2, and then accelerated from s2 to return to s1 again.

After the tailing edge of the Nth banknote B_{N} in the transport direction leaves the transport-unit-side working point 15a, the banknote B_{N} receives force from only the tape 43. Thus, no compression force (force to bend) nor tension (force to tear off) acts on the banknote B even when the moving speed of the tape 43 is different from the transport speed s1 of the transport unit 15.

It is accordingly possible to reduce the moving speed of the tape 43 from s1 to s2 after the tailing edge of the Nth banknote B_{N} in the transport direction leaves the transport-unit-side working point 15a. When the moving speed of the tape 43 is reduced, a banknote B_{N+1}, which is the N+1th banknote being transported by the transport unit 15, moves faster than the banknote B_{N} transported by the tape 43, and thus the interval between the banknotes becomes shorter than d1.

If the moving speed of the tape 43 remains slower than the transport speed s1 of the transport unit 15, however, the moving speed acting on the leading-edge side of the banknote B_{N+1} and the moving speed acting on the tailing-edge side of the banknote B_{N+1} would be different from each other when the leading edge of the banknote B_{N+1} in the transport direction reaches the storage-unit-side working point 40a. Such a situation causes compression force on the banknote B_{N+1} and the banknote B_{N+1} is bent accordingly. This possibly leads to a problem such as a jammed banknote between the transport unit 15 and the winding-type storage unit 23.

With this regard, the moving speed of the tape 43 is returned to s1 by the time when the leading edge of the banknote B_{N+1} in the transport direction reaches the storage-unit-side working point 40a. This causes force on both the leading-edge side and the tailing-edge side of the banknote B_{N+1} to move at the speed s1 when the leading edge of the banknote B_{N+1} in the transport direction reaches the storage-unit-side working point 40a. Thus, the banknote B_{N+1} is smoothly passed to and stored in the winding-type storage unit 23. In addition, the interval between the banknote B_{N} and the banknote B_{N+1} becomes d2, which is shorter than d1.

As described above, the interval between the banknotes can be shorter by reducing the moving speed of the tape 43 and returning to the original speed after the tailing edge of the Nth banknote B_{N} in the transport direction leaves the transport-unit-side working point 15a and before the leading edge of the N+1th banknote B_{N+1} in the transport direction reaches the storage-unit-side working point 40a. Besides, it is possible to increase the number of the banknotes B to be stored in the winding-type storage unit 23.

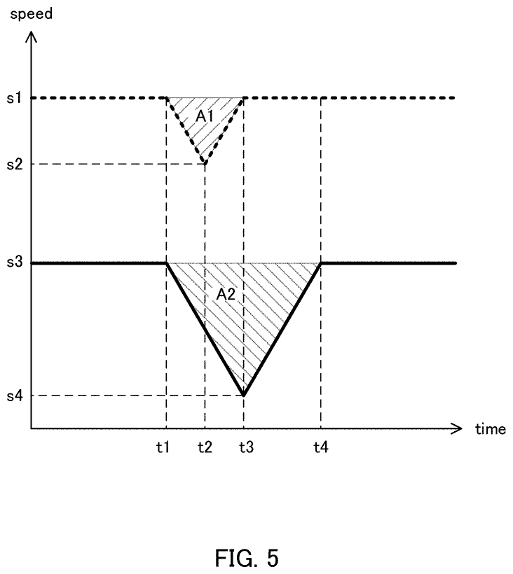

Next, shortened amounts of the banknote intervals will be described with reference to FIG. 5. The broken line illustrated on the upper side of FIG. 5 indicates a time chart for the case that has been described with reference to FIG. 4B. This time chart will be described first.

Until the time t1, the banknote B_{N} transported by the transport unit 15 and the tape 43 moves at the speed s1.

At the time t1, the tailing edge of the banknote B_{N} in the transport direction leaves the transport-unit-side working point 15a. At this time, the tape 43 starts to decelerate, that is, the winding speed starts to be reduced. The tape 43 and the banknote B_{N} decelerate at a predetermined deceleration rate.

At the time t2, the tape 43 stops the deceleration. The speed of the tape 43 and the banknote B_{N} at this time is s2. At the same time, the tape 43 starts to accelerate. The tape 43 and the banknote B_{N} accelerate at a predetermined acceleration rate.

At the time t3, the speed of the tape 43 and the banknote B_{N} reaches s1. The tape 43 stops the acceleration. At the same time, the leading edge of the banknote B_{N+1} in the transport direction reaches the storage-unit-side working point 40a, and starts to be transported by the transport unit 15 and the tape 43.

In FIG. 5, the area of the zone indicated by A1 corresponds to the shortened amount of the interval between the banknote B_{N} and the banknote B_{N+1} (that is, the difference between d1 and d2). Note that the time t3 is determined so that the difference between the time t3 and the time t1 is equal to a value resulting from dividing the interval d1, which is the interval between the banknote B_{N} and the banknote B_{N+1} before shortened, by the speed s1 (that is, t3−t1=d1/s1). The time t2 is determined based on the deceleration rate and the acceleration rate of the tape 43, and the difference between the time t3 and the time t1. For example, in a case where the absolute values of the deceleration rate and the acceleration rate of the tape 43 are equal, the time t2 is determined to be the time in the middle of the time t1 and the time t3 (that is, t2−t1=t3−t2).

Note that the speed s2 is a target speed determined based on the time reserved for deceleration (t2−t1), the time reserved for acceleration (t3−t2), the deceleration rate, and the acceleration rate. The sum of the time reserved for deceleration and the time reserved for acceleration is automatically determined by the transport speed s1 in the transport unit 15 and the interval d1 between the banknotes B. The time reserved for deceleration and the time reserved for acceleration are each determined by the absolute values of the deceleration rate and the acceleration rate. Thus, the speed s2, which is a target speed, is determined depending on the deceleration rate and the acceleration rate, and can be achieved by adjusting the deceleration rate and the acceleration rate.

Further, the transport speed of the transport unit 15 and the moving speed of the tape 43, which is the winding speed of the winding body 46, can be reduced in the present embodiment. The solid line illustrated on the lower side of FIG. 5 indicates a time chart for the case where the transport speed of the transport unit 15 is reduced.

Until the time t1, the transport unit 15 and the tape 43 transport the banknote B_{N} at the speed s3, which is slower than the speed s1. FIG. 5 illustrates a case where the speed s3 is half the speed s1 although it is not limited to this.

At the time t1, the tailing edge of the banknote B_{N} in the transport direction leaves the transport-unit-side working point 15a. At this time, the tape 43 starts to decelerate, that is, the winding speed starts to be reduced. In other words, deceleration of the winding speed toward a target speed is started. The tape 43 and the banknote B_{N} decelerate at a predetermined deceleration rate. The deceleration rate at this time may be equal to or different from the deceleration rate in the case where the transport speed of the transport unit 15 is not reduced (the case of the broken line in FIG. 5). FIG. 5 illustrates a case where both the deceleration rates are equal.

At the time t3, the tape 43 stops the deceleration. The speed of the tape 43 and the banknote B_{N} at this time is s4. At the same time, the tape 43 starts to accelerate. The tape 43 and the banknote B_{N} accelerate at a predetermined acceleration rate. The acceleration rate at this time may be equal to or different from the acceleration rate in the case where the transport speed of the transport unit 15 is not reduced (the case of the broken line in FIG. 5). FIG. 5 illustrates a case where both the acceleration rates are equal.

At the time t4, the speed of the tape 43 and the banknote B_{N} reaches s3. The tape 43 stops the acceleration. At the same time, the leading edge of the banknote B_{N+1} in the transport direction reaches the storage-unit-side working point 40a, and starts to be transported by the transport unit 15 and the tape 43.

In FIG. 5, the area of the zone indicated by A2 corresponds to the shortened amount of the interval between the banknote B_{N} and the banknote B_{N+1} (that is, the difference between d1 and d2) in the case where the transport speed of the transport unit 15 is reduced. Note that the time t4 is determined so that the difference between the time t4 and the time t1 is equal to a value resulting from dividing the interval d1, which is the interval between the banknote B_{N} and the banknote B_{N+1} before shortened, by the speed s3 (that is, t4−t1=d1/s3). The time t3 is determined based on the deceleration rate and the acceleration rate of the tape 43, and the difference between the time t4 and the time t1. For example, in a case where the absolute values of the deceleration rate and the acceleration rate of the tape 43 are equal, the time t3 is determined to be the time in the middle of the time t1 and the time t4 (that is, t3−t1=t4−t3).

Note that the speed s4 is a target speed determined based on the time reserved for deceleration (t3−t1), the time reserved for acceleration (t4−t3), the deceleration rate, and the acceleration rate. The sum of the time reserved for deceleration and the time reserved for acceleration is automatically determined by the transport speed s3 in the transport unit 15 and the interval d1 between the banknotes B. The time reserved for deceleration and the time reserved for acceleration are each determined by the absolute values of the deceleration rate and the acceleration rate. Thus, the speed s4, which is a target speed, is determined depending on the deceleration rate and the acceleration rate, and can be achieved by adjusting the deceleration rate and the acceleration rate.

As is clear from FIG. 5, the area of the zone A2 is larger than the area of the zone A1. That is, the interval between banknotes B can be further shortened by reducing the transport speed of the transport unit 15. The following is the reason why the area of the zone A2 is larger than the area of the zone A1.

When the transport speed of the transport unit 15 and the moving speed of the tape 43 before the speed reduction is reduced from s1 to s3, more time is required after the tailing edge of the banknote B_{N} in the transport direction leaves the transport-unit-side working point 15a and before the leading edge of the banknote B_{N+1} in the transport direction reaches the storage-unit-side working point 40a. That is, the time when the deceleration is completed is delayed from t2 to t3, and the time when the acceleration is completed is delayed from t3 to t4. In addition, those delays cause a great difference in the speed before and after the deceleration. That is, the difference between s3 and s4 is greater than the difference between s1 and s2. Accordingly, the area of the zone A2 is larger than the area of the zone A1.

Therefore, in the present embodiment, the reduction of the transport speed for banknotes transported by the transport unit 15 shortens the interval between banknotes B to be stored in the winding-type storage unit 23, and further, increases the number of the banknotes B to be stored in the winding-type storage unit 23.

Note that, in FIG. 5, the deceleration rates and the acceleration rates are assumed to be equal between the cases where the transport speed is s1 and s3. The inertial force of the winding body 46, however, is less in the case where the transport speed is s3 than that in the case where the transport speed is s1 since s3 is less than s1. With this regard, in the case where the transport speed is s3, the absolute values of the deceleration rate and the acceleration rate are set greater than those in the case where the transport speed is s1. That is, the transport speed can reach the target speed s4 more quickly and can return to the original speed s3 more quickly. Such an operation makes the value of the target speed s4 less than the value illustrated in FIG. 5, thereby making the area of the zone A2 even larger, i.e., increasing the shortened amount of the interval between the banknote B_{N} and the banknote B_{N+1}. The shortened amount of the interval between the banknote B_{N} and the banknote B_{N+1} increases as the target speed s4 decreases. The target speed s4 can be set to 0.

Further, when it is possible to set greater absolute values of the deceleration rate and the acceleration rate, rotation of the winding body 46 may be stopped for a predetermined time in addition to setting the target speed s4 to 0. In this case, the shape of a zone corresponding to the zone A2 is a trapezoid, the area of the zone is even larger, and the shortened amount of the interval between the banknote B_{N} and the banknote B_{N+1} increases even more.

Although the description so far is about a case where banknotes B are continuously stored in the winding-type storage unit 23, this is not only the case producing the above-described effect. It is possible to achieve the effect of increasing the storage amount by reducing the transport speed for banknotes transported by the transport unit 15 in a case where banknotes B are intermittently stored, that is, in a case where a banknote B is stored after a relatively long time interval from the time when the previous banknote B is stored.

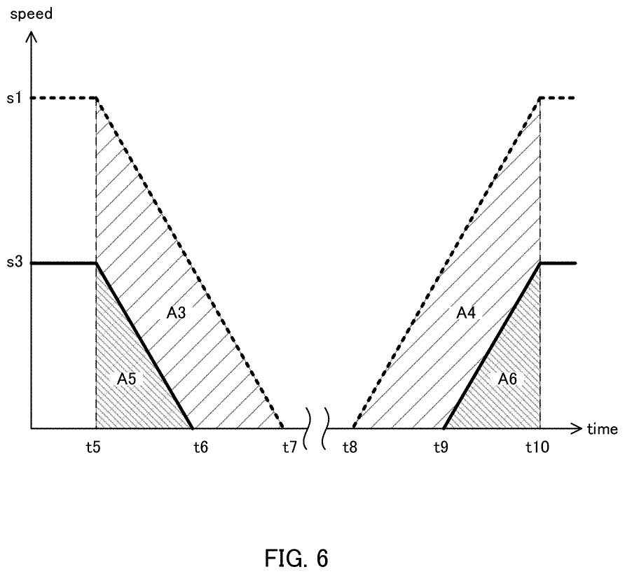

FIG. 6 is a time chart illustrating the moving speed of the banknote B_{N} in the case where banknotes B are intermittently stored in the winding-type storage unit 23. The broken lines indicate a time chart for the case where the transport speed for the banknote is s1, which is a relatively fast speed. The solid lines indicate a time chart for the case where the transport speed for the banknote is s3, which is slower than s1.

The case where the transport speed for the banknote is s1 will be described first. When the tailing edge in the transport direction of the banknote B_{N} that has been intermittently transported passes through, for example, the transport-unit-side working point 15a at the time t5, the processing circuitry 18 stops the drive unit 45. Note that the winding body 46 is configured by the drum 42, the tape 43, and banknotes B that have been wound thereon, and has a certain mass. The winding body 46 rotates to some extent due to inertial force, accordingly. Thus, the winding body 46 actually stops at the time t7, and the banknote B_{N} is moved to some extent by the tape 43 between the time t5 and the time t7. The amount of the movement corresponds to the area of the triangle zone indicated by A3 in FIG. 6.

The moving speed of the tape 43 needs to reach s1 by the time when the leading edge of the following banknote B_{N+1} in the transport direction reaches the storage-unit-side working point 40a. The winding body 46 has a certain mass, however, as described above, and the rotation speed of the winding body 46, which is the moving speed of the tape 43, does not reach s1 immediately after the drive unit 45 starts to drive. With this regard, when the leading edge of the banknote B_{N+1} in the transport direction is assumed to reach the storage-unit-side working point 40a at the time t10, the tape 43 needs to start moving at the time t8, which is some time earlier than the time t10. The amount of the movement corresponds to the area of the triangle zone indicated by A4 in FIG. 6.

In the case where banknotes B are intermittently stored, the interval between the banknotes B is eventually determined as follows.

1. Contribution by Operation Control for the Drum 42

The operation control for the drum 42 causes the tape 43 to move a predetermined distance, which corresponds to the sum of the area of the zone A3 and the area of the zone A4, between the time t5 and the time t10. As described above, the time t5 is the timing at which the tailing edge of the banknote B_{N} is about to reach the transport-unit-side working point 15a and the moving speed of the tape 43 starts to reduce from s1. That is, the time t5 is a timing for the drive unit 45 to stop. In addition, the time t10 is the timing at which the leading edge of the banknote B_{N+1} is about to reach the storage-unit-side working point 40a and the speed of the tape 43 is back to s1.

2. Contribution by Operation of Transport Unit 15

The operation of the transport unit 15 causes transportation of the banknote B_{N+1} between the time t5 and the time t10. At the time t10, the leading edge of the banknote B_{N+1} is positioned on the upstream side, that is, the reel 41 side, in the transport direction from the storage-unit-side working point 40a. The closer the leading edge of the banknote B_{N+1} is to the storage-unit-side working point 40a at the time t10, the greater the effect of shortening the interval between the banknotes B is. In the following, the distance between the leading edge of the banknote B_{N+1} and the transport-unit-side working point 15a, which is the length of the banknote B_{N+1} sticking out from the transport-unit-side working point 15a to the drum 42 side, at the time t10 is represented by X.

3. Interval Between Banknotes B (Interval Between the Tailing Edge of the Banknote B_{N} and the Leading Edge of the Banknote B_{N+1} in the Transport Direction)

The operation control for the transport unit 15 and the drum 42 may be changed as appropriate as long as the condition is satisfied where the moving speed of the tape 43 reaches s1 by the time when the leading edge of the banknote B_{N+1}, which follows the banknote B_{N}, in the transport direction reaches the storage-unit-side working point 40a. Thus, the interval d2 between the banknotes B stored in the winding-type storage unit 23 is determined as follows, according to 1 and 2 described above.

Interval d2 between banknotes B=(Area of zone A3+Area of zone A4)−(Distance X between the leading edge of a following banknote B_{N+1} and the transport-unit-side working point 15a at the time when the moving speed of the tape 43 is returned to s1, which is the same as the transport speed s1 of the transport unit 15)

Next, the case where the transport speed for the banknote is s3 will be described. FIG. 6 illustrates a case where the speed s3 is half the speed s1 although it is not limited to this.

When the tailing edge in the transport direction of the banknote B_{N} that has been intermittently transported passes through, for example, the transport-unit-side working point 15a at the time t5, the processing circuitry 18 stops the drive unit 45. Note that the winding body 46 has a certain mass as described above; accordingly, the winding body 46 rotates to some extent due to inertial force. Thus, the winding body 46 actually stops (the winding speed becomes 0) at the time t6, and the banknote B_{N} is moved to some extent by the tape 43 between the time t5 and the time t6. The amount of the movement corresponds to the area of the zone indicated by A5 in FIG. 6.

The moving speed of the tape 43 needs to reach s3 by the time when the leading edge of the following banknote B_{N+1} in the transport direction reaches the storage-unit-side working point 40a. The winding body 46 has a certain mass, however, as described above, and the rotation speed of the winding body 46, which is the moving speed of the tape 43, does not reach s3 immediately after the drive unit 45 starts to drive. With this regard, when the leading edge of the banknote B_{N+1} in the transport direction is assumed to reach the storage-unit-side working point 40a at the time t10, the tape 43 needs to start moving at the time t9, which is some time earlier than the time t10. The amount of the movement corresponds to the area of the zone indicated by A6 in FIG. 6.

The final interval d2 between the banknotes B in the case where the banknotes are intermittently transported at the transport speed s3 is determined in the same manner as in the case where the transport speed is s1. That is, the interval d2 is determined as follows.

Interval d2 between banknotes B=(Area of zone A5+Area of zone A6)−(Distance X between the leading edge of a following banknote B_{N+1} and the transport-unit-side working point 15a at the time when the moving speed of the tape 43 is returned to s3, which is the same as the transport speed s3 of the transport unit 15)

As is clear from FIG. 6, the sum of the area of the zone A5 and the area of the zone A6 is smaller than the sum of the area of the zone A3 and the area of the zone A4. That is, the interval between banknotes B can be shortened by reducing the transport speed of the transport unit 15 even in the case where the banknotes B are intermittently transported. Further, the reduction of the transport speed increases the number of the banknotes B to be stored in the winding-type storage unit 23.

Note that, in FIG. 6, the deceleration rates and the acceleration rates are assumed to be equal between the cases where the transport speed is s1 and s3. The inertial force of the winding body 46, however, is less in the case where the transport speed is s3 than that in the case where the transport speed is s1 since s3 is less than s1. With this regard, in the case where the transport speed is s3, the absolute values of the deceleration rate and the acceleration rate are set greater than those in the case where the transport speed is s1. That is, the winding body 46 can be stopped more quickly and the speed can return to the speed s3 more quickly. Such an operation makes the sum of the area of the zone A5 and the area of the zone A6 smaller than the sum of the areas illustrated in FIG. 6, thereby increasing the shortened amount of the interval between the banknote B_{N} and the banknote B_{N+1}. It is thus possible to increase the number of the banknotes B to be stored in the winding-type storage unit 23.

Needless to say, the temporary storage unit 17 comprising the banknote storage unit 40 can also increase the number of the banknotes B to be stored in the same manner as the winding-type storage unit 23.

<Patterns of Control for Increasing Storage Amount>

Next, descriptions will be given of examples of patterns where control is performed to increase the number of the banknotes B to be stored. Before the descriptions of the examples, a condition under which the control is performed to increase the number of stored banknotes will be described.

<Pattern 1>

The pattern 1 is control of moving banknotes stored in one of the winding-type storage units 23 to the temporary storage unit 17, temporarily storing the banknotes in the temporary storage unit 17, and moving the banknotes back in the original winding-type storage unit 23, in order to increase the number of the banknotes stored in the one of the winding-type storage units 23. In the following, the one of the winding-type storage units 23 is referred to as a “first storage”, and the temporary storage unit 17 is referred to as a “second storage” in the present pattern.

This control can be performed when the first storage is in a predetermined state. The first example of the predetermined state is that the number of banknotes stored in the first storage reaches a predetermined value. The processing circuitry 18 can count the number of banknotes stored in the first storage based on signals from a sensor that is comprised in the first storage and detects passage of banknotes.

The second example of the predetermined state is that the diameter of the winding body 46 reaches a predetermined value. The processing circuitry 18 can calculate the diameter of the winding body 46 based on the number of steps of each stepper motor in a case where the drive units 44 and 45 are stepper motors.

The third example of the predetermined state is that the interval between banknotes wound around the drum 42, i.e., the winding body 46, satisfies a predetermined condition. The predetermined condition may be, for example, that the mean value of the intervals between the wound banknotes reaches a predetermined threshold. The predetermined condition may also be that the degree of variability of the intervals between the wound banknotes reaches a predetermined threshold. Note that the processing circuitry 18 can obtain information on the interval between the banknotes by calculating the interval between the banknotes based on the number of steps of each stepper motor in a case where the drive units 44 and 45 are stepper motors.

When the first storage is in the predetermined state described above, the processing circuitry 18 controls the first storage, the second storage, and the transport unit 15 to increase the number of stored banknotes. Note that the banknotes stored in the first storage before the control to increase the number of stored banknotes are, for example, banknotes that are deposited from the inlet 12, recognized by the recognition unit 16, temporarily stored in the second storage, and stored in the first storage. Those banknotes are banknotes that have been stored in the first storage according to the time chart indicated by the broken line in FIG. 5. That is, before the control to increase the number of stored banknotes, the transport speed for banknotes by the transport unit 15 is relatively fast; accordingly, the banknote processing apparatus 1 can process a large amount of banknotes quickly.

Under the control of the processing circuitry 18, the transport unit 15 transports the banknotes stored in the first storage to the second storage at a first transport speed. The first transport speed may be the speed s1 illustrated in FIG. 5. This operation enables quick movement of the banknotes.

Under the control of the processing circuitry 18, the transport unit 15 then transports the banknotes stored in the second storage to the first storage at a second transport speed. The second transport speed is slower than the first transport speed. The second transport speed may be the speed s3 illustrated in FIG. 5.

At this time, under the control of the processing circuitry 18, the first storage (drive units 44 and 45 in particular) stores the banknotes while increasing and reducing the winding speed according to the time chart indicated by the solid line in FIG. 5. That is, the processing circuitry 18 controls the first storage so that the winding speed is a first winding speed that is slower than the second transport speed. The first winding speed may be the speed s4 illustrated in FIG. 5.

Such control shortens the interval between the banknotes stored in the first storage, thus increasing the number of banknotes stored in the first storage.

Note that the control to increase the number of banknotes is preferentially performed when the operating rate of the banknote processing apparatus 1 is low (e.g., at night) since the second transport speed is slower than the first transport speed. With this regard, the processing circuitry 18 may obtain time information, and perform the above-described control based on the time information, e.g., after business hours of a store where the banknote processing apparatus 1 is installed.

Further, the control in the pattern 1 may be performed together with so called reconciliation processing. That is, the banknotes stored in the first storage may be transported to the recognition unit 16 and recognized by the recognition unit 16 before being transported to the second storage.

<Pattern 2>

The pattern 2 is control of moving banknotes stored in one of the winding-type storage units 23 to a different one of the winding-type storage units 23, temporarily storing the banknotes in the different one of the winding-type storage units 23, and moving the banknotes back in the original winding-type storage unit 23, in order to increase the number of the banknotes B stored in the one of the winding-type storage units 23. In the following, the winding-type storage unit 23 that originally and eventually stores the banknotes is referred to as a “first storage”, and the winding-type storage units 23 that temporarily stores the banknotes is referred to as a “second storage” in the present pattern.

The control in the pattern 2 is the same as the control in the pattern 1 except that the second storage is changed from the temporary storage unit 17 to one of the winding-type storage units 23. Thus, as is the case with the control in the pattern 1, the control in the pattern 2 shortens the interval between the banknotes stored in the first storage, thereby increasing the number of banknotes stored in the first storage.

Further, the control in the pattern 2 can be performed without feeding out banknotes from the storage 20, that is, without feeding out from the safe. This eliminates the risk of a banknote getting jammed when moving back and forth between the storage 20 and the processing unit 10. In addition, the inside of the storage 20 cannot be accessed from the outside unless the lockable door is unlocked. Thus, it is possible to move banknotes while reducing the probability of unexpected events.

Note that the banknote moved from the first storage to the second storage need not be immediately moved back to the first storage. For example, the banknote may be moved back from the second storage to the first storage when the interval between the banknotes stored in the second storage satisfies a predetermined condition after the banknote is moved from the first storage to the second storage. The predetermined condition may be, for example, that the mean value of the intervals between the wound banknotes reaches a predetermined threshold. The predetermined condition may also be that the degree of variability of the intervals between the wound banknotes reaches a predetermined threshold. The processing circuitry 18 can obtain information on the interval between the banknotes by calculating the interval between the banknotes based on the number of steps of each stepper motor in a case where the drive units 44 and 45 of the banknote storage unit 40 comprised in the temporary storage unit 17, which is the second storage, are stepper motors.

<Pattern 3>

As in the pattern 1, the pattern 3 is control of moving banknotes stored in one of the winding-type storage units 23 to the temporary storage unit 17, temporarily storing the banknotes in the temporary storage unit 17, and moving the banknotes back in the original winding-type storage unit 23, in order to increase the number of the banknotes stored in the one of the winding-type storage units 23. In the following, the one of the winding-type storage units 23 is referred to as a “first storage”, and the temporary storage unit 17 is referred to as a “second storage” in the present pattern.

In the control in the pattern 3, the transport speed and the winding speed are reduced when the banknotes are moved from the first storage to the second storage and temporarily stored as well as when the banknotes are moved back from the second storage to the first storage. The control in the pattern 3 is the same as the control in the pattern 1 otherwise.

In the pattern 3, the control is specifically performed as follows.

When the first storage is in the predetermined state described in the pattern 1, the processing circuitry 18 controls the first storage, the second storage, and the transport unit 15 to increase the number of stored banknotes.

Under the control of the processing circuitry 18, the transport unit 15 transports the banknotes stored in the first storage to the second storage at a first transport speed. The first transport speed may be the speed s3 illustrated in FIG. 5. That is, the transport speed for the banknotes is already slower than usual at this stage.

At this time, under the control of the processing circuitry 18, the second storage (more specifically, the drive units 44 and 45 of the banknote storage unit 40 comprised in the temporary storage unit 17) stores the banknotes while increasing and reducing the winding speed according to the time chart indicated by the solid line in FIG. 5. That is, the processing circuitry 18 controls the second storage so that the winding speed is a second winding speed that is slower than the first transport speed. The second winding speed may be the speed s4 illustrated in FIG. 5.

Thus, at this stage, the interval between the banknotes stored in the second storage is shorter than the interval when the banknotes were previously stored in the first storage.

Under the control of the processing circuitry 18, the transport unit 15 then transports the banknotes stored in the second storage to the first storage at a second transport speed. The second transport speed is slower than the first transport speed. The second transport speed may be slower than the speed s3 illustrated in FIG. 5.

At this time, under the control of the processing circuitry 18, the first storage (drive units 44 and 45 in particular) stores the banknotes while increasing and reducing the winding speed. That is, the processing circuitry 18 controls the first storage so that the winding speed is a first winding speed that is slower than the second transport speed. The first winding speed is slower than the second winding speed.

When the banknotes return to the first storage, the interval between the banknotes is even shorter than the interval when the banknotes were previously stored in the second storage. That is, such control further shortens the interval between the banknotes stored in the first storage, thus further increasing the number of banknotes stored in the first storage.

<Pattern 4>

As in the pattern 2, the pattern 4 is control of moving banknotes stored in one of the winding-type storage units 23 to a different one of the winding-type storage units 23, temporarily storing the banknotes in the different one of the winding-type storage units 23, and moving the banknotes back in the original winding-type storage unit 23, in order to increase the number of the banknotes stored in the one of the winding-type storage units 23. In the following, the winding-type storage units 23 that originally and eventually stores the banknotes is referred to as a “first storage”, and the winding-type storage units 23 that temporarily stores the banknotes is referred to as a “second storage” in the present pattern.

In the control in the pattern 4, each unit is controlled so that the winding speed is reduced when the banknotes are moved from the first storage to the second storage and temporarily stored as well as when the banknotes are moved back from the second storage to the first storage. This operation is common to the pattern 3 and different from the pattern 2. The control in the pattern 4 is the same as the control in the pattern 2 otherwise.

Thus, as is the case with the control in the pattern 3, the control in the pattern 4 further shortens the interval between the banknotes stored in the first storage, thereby further increasing the number of banknotes stored in the first storage.

In addition, as in the control in the pattern 2, the control in the pattern 4 can be performed without feeding out banknotes from the storage 20, that is, without feeding out from the safe. This eliminates the risk of a banknote getting jammed when moving back and forth between the storage 20 and the processing unit 10. Further, the inside of the storage 20 cannot be accessed from the outside unless the lockable door is unlocked. Thus, it is possible to move banknotes while reducing the probability of unexpected events.

<Pattern 5>

The pattern 5 is control performed at the time of so called deposit processing. The pattern 5 is control for storing as many banknotes as possible in one of the winding-type storage units 23 from the beginning. In the following, the one of the winding-type storage units 23 is referred to as a “first storage”, and the temporary storage unit 17 is referred to as a “second storage” in the present pattern.

The control in the pattern 5 is performed as follows. First, banknotes deposited from the inlet 12 are transported to the recognition unit 16 by the transport unit 15 and recognized, under the control of the processing circuitry 18. The banknotes are then transported to the second storage and temporarily stored. During the operation, the transport unit 15 transports the banknotes at a first transport speed. The first transport speed may be the speed s1 illustrated in FIG. 5.

Under the control of the processing circuitry 18, the transport unit 15 then transports the banknotes stored in the second storage to the first storage at a second transport speed. The second transport speed is slower than the first transport speed. The second transport speed may be the speed s3 illustrated in FIG. 5.

At this time, under the control of the processing circuitry 18, the first storage (drive units 44 and 45 in particular) stores the banknotes while increasing and reducing the winding speed according to the time chart indicated by the solid line in FIG. 5. That is, the processing circuitry 18 controls the first storage so that the winding speed is a first winding speed that is slower than the second transport speed. The first winding speed may be the speed s4 illustrated in FIG. 5.

Such control makes it possible to store the banknotes in the first storage with shortened intervals from the beginning, thus increasing the number of banknotes stored in the first storage.

In addition, the transport speed to transport the banknotes to the second storage can be set to the first transport speed, which is a relatively fast speed. This minimizes the increase in processing time required for deposit processing.

Further, the second transport speed is slower than the first transport speed; accordingly, the banknote processing apparatus 1 makes less noise when the transport unit 15 moves at the second transport speed than when the transport unit 15 moves at the first transport speed. Thus, the control described above may be actively performed as a so-called silent mode during business hours of a store.

<Variations>

The banknote processing apparatus 1 can also extend the interval between banknotes to be stored in the first storage. The interval between banknotes stored in the first storage can be extended by, for example, not reducing but increasing the rotation speed of the winding body 46 (more specifically, accelerating and then decelerating to the original speed) when the banknotes are being stored in the first storage. That is, the banknote processing apparatus 1 can either shorten or extend the interval between banknotes to be stored in the first storage. In other words, the banknote processing apparatus 1 can adjust the interval between banknotes to be stored in the first storage to an appropriate length. At this time, the accuracy of the interval between banknotes can be improved by reducing the speed to transport banknotes to the first storage by the transport unit 15.

Thus, the banknote processing apparatus 1 can easily determine a group of banknotes for a single transaction by extending the interval between a group of banknotes and another group of banknotes to be processed. In addition, arrangement positions of banknotes in the winding body 46 can be adjusted by appropriately adjusting the interval between the banknotes. This makes it easy to maintain the shape of a cut surface of a plane perpendicular to the rotation axis E2 (see FIGS. 2 and 3) of the winding body 46 in a circular shape.

The first storage may be a storage unit that can be detachably attached to the banknote processing apparatus 1. For example, the first storage may be a storage unit to be attached to the banknote processing apparatus 1 after banknotes are stored in the first storage by an apparatus other than the banknote processing apparatus 1. In this case, banknotes stored in the first storage are temporarily moved to the second storage, which is the temporary storage unit 17 or the winding-type storage unit 23, and then moved bank in the first storage, thereby shortening the interval between the banknotes, i.e., increasing the amount of banknotes to be stored in the first storage.

### INDUSTRIAL APPLICABILITY

The present disclosure is suitable for a sheet processing apparatus that processes sheets such as banknotes.

### REFERENCE SIGNS LIST

1 Banknote processing apparatus
10 Processing unit
11 Upper housing
12 Inlet
13 Outlet
14 Second outlet
15 Transport unit
150 Loop transport path
151 First divergent path
152 Second divergent path
153 Third divergent path
154 Fourth divergent path
155 Fifth divergent path
15a Transport-unit-side working point
16 Recognition unit
17 Temporary storage unit
18 Control unit
19 Memory unit
20 Storage
21 Lower housing
22 Stacking-type storage unit
23 Winding-type storage unit
40 Banknote storage unit
40a Storage-unit-side working point
41 Reel
42 Drum
43, 43a, 43b Tape
44, 45 Drive unit
46 Winding body

1. A sheet processing apparatus, comprising:
a first storage that is a winding-type storage where a sheet is wound around a drum together with a tape and stored;
a second storage that stores the sheet;
a transport unit that transports the sheet to the second storage at a first transport speed and transports the sheet from the second storage to the first storage at a second transport speed; and
a processing circuitry that controls the first storage , the second storage , and the transport unit so that the second transport speed is slower than the first transport speed and a winding speed for winding the sheet by the first storage is a first winding speed that is slower than the second transport speed.

2. The sheet processing apparatus according to claim 1, wherein, in a case that a number of a plurality of the sheets stored in the first storage is greater than or equal to a predetermined value, the processing circuitry controls the first storage, the second storage, and the transport unit so that the plurality of sheets stored in the first storage are temporarily stored in the second storage and then returned to the first storage.

3. The sheet processing apparatus according to claim 1, wherein, in a case that a diameter of a winding body including the sheet, the tape, and the drum is greater than or equal to a predetermined value, the processing circuitry controls the first storage, the second storage, and the transport unit so that the sheet stored in the first storage is temporarily stored in the second storage and then returned to the first storage.

4. The sheet processing apparatus according to claim 1, wherein the processing circuitry controls, based on information on an interval between a plurality of the sheets wound around the drum in the first storage, the first storage, the second storage, and the transport unit so that the plurality of sheets stored in the first storage are temporarily stored in the second storage and then returned to the first storage.

5. The sheet processing apparatus according to claim 1, wherein the processing circuitry acquires time information, and wherein the processing circuitry controls, based on the time information, the first storage, the second storage, and the transport unit so that the sheet stored in the first storage is temporarily stored in the second storage and then returned to the first storage.

6. The sheet processing apparatus according to claim 1, further comprising a recognition unit that recognizes the sheet being transported by the transport unit, wherein the processing circuitry controls the first storage, the second storage, and the transport unit so that the sheet recognized by the recognition unit is temporarily stored in the second storage and then stored in the first storage.

7. The sheet processing apparatus according to claim 6, wherein the processing circuitry controls, based on information on an interval between a plurality of the sheets stored in the second storage, the first storage, the second storage, and the transport unit so that the plurality of sheets stored in the second storage are transported from the second storage to the first storage.

8. The sheet processing apparatus according to claim 6, further comprising an inlet that takes in the sheet, wherein the transport unit transports the sheet from the inlet to the second storage via the recognition unit at the first transport speed.

9. The sheet processing apparatus according to claim 1, further comprising a recognition unit that recognizes the sheet transported by the transport unit, wherein the processing circuitry controls the first storage, the second storage, and the transport unit so that the sheet stored in the first storage is recognized by the recognition unit and then stored in the second storage.

10. The sheet processing apparatus according to claim 1, wherein,
the second storage is a winding-type storage where the sheet is stored by being wound around a drum together with a tape, and
the processing circuitry controls the first storage, the second storage, and the transport unit so that the sheet is transported from the first storage to the second storage at the first transport speed and a second winding speed for winding the sheet by the second storage is slower than the first transport speed and faster than the first winding speed.

11. The sheet processing apparatus according to claim 1, further comprising a lockable chest, wherein the first storage is placed in the lockable chest.

12. The sheet processing apparatus according to claim 11, wherein the second storage is placed in the lockable chest.

13. The sheet processing apparatus according to claim 1, wherein,
the transport unit has a transport-unit-side working point located closest to the first storage in a section where the transport unit exerts a force to the sheet,
the first storage has a first-storage-side working point located closest to the transport unit in a section where the first storage exerts a force to the sheet,
a distance between the transport-unit-side working point and the first-storage-side working point is shorter than a transport-direction length of the sheet, and
the processing circuitry controls the first storage and the transport unit so as to start deceleration of the winding speed to a target speed when a tailing edge, in a moving direction, of the sheet to be passed from the transport unit to the first storage reaches the first-storage-side working point, the target speed being referred to as the first winding speed.

14. The sheet processing apparatus according to claim 13, wherein,
the sheet is one of a plurality of types of sheets which are different from each other in the transport-direction length; and
the distance is shorter than the transport-direction length of the sheet with a shortest transport-direction length among the plurality of types of sheets.

15. The sheet processing apparatus according to claim 13, wherein the processing circuitry controls the first storage and the transport unit so as to start deceleration of the winding speed from the first winding speed to a target speed of 0.
